(19) United States
(12) Patent Application Publication
(10) Pub. No.: US 2015/0033624 A1
(43) Pub. Date: Feb. 5, 2015

(54) BIODEGRADABLE POT DRYING INSTALLATION, MANUFACTURING INSTALLATION AND ASSOCIATED METHOD OF MANUFACTURE, AND BIODEGRADABLE POT OBTAINED ACCORDING TO THE INVENTION

(71) Applicants: Guy De La Martiniere, Boulogne Billancourt (FR); Marc Micquel, Epinal (FR)

(72) Inventors: Guy De La Martiniere, Boulogne Billancourt (FR); Marc Micquel, Epinal (FR)

(73) Assignee: FERTIL, Le Syndicat (FR)

(21) Appl. No.: 14/379,349

(22) PCT Filed: Mar. 1, 2013
(86) PCT No.: PCT/FR2013/050440

§ 371 Date: Aug. 18, 2014

(30) Foreign Application Priority Data
Mar. 7, 2012 (FR) 1252049

(51) Int. Cl. B28B 11/24; F26B 3/02; A01G 9/02; B28B 1/24; B28B 7/34

(52) U.S. Cl. CPC B28B 11/243; B28B 1/24; B28B 7/344; A01G 9/02; F26B 3/02
USPC 47/65.5; 425/547; 34/201; 34/92; 34/218; 34/282; 34/412

(57) ABSTRACT

An installation for drying a thin-walled biodegradable pot having a drying mould wherein one wall has a shape adapted to a corresponding shape of a wall of a moulded pot to be dried, and a means of heating the drying mould wall to a temperature above 160° C., and preferably between 180 and 240° C. Also disclosed are an installation for manufacturing pots having a drying installation mentioned above, a method of drying pots, a pot obtained from an installation or from a method mentioned above, and an assembly with a plant in a pot as mentioned above.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention relates to an installation for drying a biodegradable pot with thin walls within the range of 0.5 to 3 mm, suitable for growing plants, an associated method and pot.

2. Description of Related Art Including Information Disclosed Under 37 CFR 1.97 and 37 CFR 1.98.

Biodegradable pots are usually manufactured as follows. A mixture of water and organic material such as peat, wood fiber, etc., permits to obtain a liquid clay, which is molded by suction of the clay into molds with walls of mesh material (of wire gauze, nylon gauze, etc.) and the shape of which is adapted to the desired shape of the pot.

The molded pots are then removed from the molds and transferred onto a drying tray, either directly using a compressed-air blowing device or through a transfer counter-mold using a compressed-air blowing device, then the tray is transferred into an hot-air oven for drying the pots. The drying time varies between ten minutes and two hours, depending namely on the composition of the clay and the thickness of the walls of the pots. After drying, the pots are stacked to be stored, and then sent in piles to the users, who are namely professional horticulturists.

It is observed in practice during industrial use in horticulture, thus in large-scale use, that the unstacking of the pots is difficult, especially the mechanical unstacking The difficulty in unstacking can be explained by the inhomogeneous shapes of the pots after drying. Indeed, as long as they are not dry, the pots tend to deform between the end of the molding and the end of drying, namely during their transfer and their displacement in the dry kiln. Likewise, simply because of gravity and the weight of the wet clay, the wall of the pot tends to settle, to wrinkle as long as the wall is not completely dry, even if the pots are not handled. This is due to the malleability of the wet clay. The deformations persist on the dry finished product and cause the difficulties of unstacking and usage of the pots.

It is also observed that, when using the pots, after filling and watering of the pots for growing plants, the pots gradually degrade, which makes their handling difficult throughout the growing process. It is also observed that the stability of the organic material corresponds to that of the original raw material, and that the drying does not improve this stability.

### BRIEF SUMMARY OF THE INVENTION

The invention aims to improve the quality of the surface finish of the walls of the pots, in order to facilitate the unstacking of the pots.

To this end, the invention provides a novel drying installation for pots, which installation comprises a drying mold, one wall of which has a shape adapted to a corresponding shape of a wall of a molded pot to be dried, and means for heating the wall of the drying mold at a temperature above 160° C.

Under these drying conditions, it is observed that the shape of the pots is improved, more homogeneous from one pot to another. The pots obtained are therefore easier to be stacked and especially easier to be unstacked mechanically.

It is also observed that, during their later use, after having been filled with cultural compost and wetted, the pots obtained from an installation according to the invention have, compared to the pots obtained from a previous installation:
a better preservation of the mechanical strength of the pots during the growth,
a stability of the organic material improved over that of the two original components.

The pots therefore degrade a little slower, and the work of the horticulturists, who handle them for several weeks is thus largely facilitated.

The drying of the pots in a mold prevents deformation of the pots during the transfer of the pots after molding and before drying, like this is the case in the prior art. Furthermore, drying at high temperature, above 160° C., in combination with heating of the wall of the mold into contact with the wall of the pot to be dried, permits a faster drying of the pots, which also limits the deformation of the pots during the drying time, which deformation is due to gravity and to the weight of the wet clay. A through and fast drying also permits a significant reduction of energy consumption for the drying.

Tests carried out at temperatures between 180 and 240° C. have provided the best results, namely for peat and wood-fiber based pots. A complete drying can thus be achieved in a period of time ranging from a few tens of seconds to a few minutes, depending on the composition of the clay used and the thickness of the pots.

With a heating beyond 260° C., a non-desired modification of certain structural properties of pots is observed: loss of dry mass, change in structure of the material forming the pots, etc. and a significant risk of carbonizing the material forming the pots.

The drying plant can also comprise means for sucking a fluid such as water and/or water vapor through at least a portion of the wall of the drying mold, at the level of a suction nozzle, for example. A suction nozzle on the wall of the mold is sufficient to suck the fluid. However, a small number of suction nozzles, e.g. 2 to 10, distributed over the entire wall of the mold, permits a more homogeneous suction. The suction can occur before the drying, to drain the pot, to extract in cold as much liquid as possible before drying, in order to limit the drying time, thus to limit the deformation of the pots and to limit the energy consumption. The suction can also occur during the drying of the pots, in order to suck the water vapor produced during the drying, but also to suck a little more the water contained in the wet pots. Indeed, hot water is easier to be removed, to be sucked than cold water; thus, while it is no longer possible to extract water from a cold pot (after molding and before drying) with a given negative pressure, it is still possible to extract warm water from a heated pot having the same humidity rate with the same negative pressure, without vaporizing the hot water. The amount of energy to be supplied during drying in order to vaporize the water contained in the wet pot is thus further limited, and the drying time is also limited.

The wall of the drying mold is preferably made of a solid material or of an openwork material such as an openwork sheet, a percentage of open area of which (i.e. the area of the holes divided by the total surface of the wall of the drying mold) is less than 25%, i.e. at least twice less than a percentage of open area corresponding to the meshes of the mesh walls of molding dies. During the molding of the pot in the molding die, the wet clay is sucked, pressed against the mesh wall of the molding die, so that the outer wall of the wet pot has asperities having the geometric shape of the meshes of the mesh wall of the molding die. When drying the pot in a drying mold with a solid wall or an openwork wall having an smaller percentage of open area, a decrease, a flattening of these asperities is observed. The wall of the pots after drying is thus smoother, so that the pots are easier to be unstacked. This reduction of the asperities is further enhanced when the fluids are sucked through the wall of the drying mold, because the suction causes an accentuated pressing of the pot against the wall of the drying mold.

The installation can also comprise a means for closing the drying mold. The air volume to be heated during drying of the pot is thus limited, and the energy required for drying is limited accordingly.

According to a variant, the means for closing the drying mold is a cover. The volume of air to be heated is thus limited to the volume of the drying mold.

According to another variant, the closing means is a drying counter-mold, a wall of which has a shape adapted to a corresponding shape of a wall of the pot. In this case, there is no longer any air to be heated unnecessarily, only the pot that fills the space between the drying mold and the drying counter-mold is heated.

The plant can comprise additionally means for heating the wall of the drying counter-mold at a temperature above 160° C., and preferably between 180 and 240° C. There is thus a more efficient and fast heating, which acts simultaneously on both sides of the walls of the pot to be dried.

The plant can comprise in addition a pressing means for compressing the pot between the drying counter-mold and the drying mold. The pot is thus immobilized between the mold and the counter-mold so that before it is dry, it can only adopt the form imposed by the walls of the mold and the counter-mold; and pressing the counter-mold against the mold has a mechanical effect of crushing the asperities of the walls of the wet pots; this further enhances the unstackability of the dry pots. Furthermore, pressing the counter-mold against the mold has an effect of mechanical centrifuging, carrying away of the water before drying, but also during drying of the pot, which further limits the duration of the drying and the energy consumption.

The drying installation according to the invention can also comprise means for injecting an inert gas into the drying mold. The inert gas is for instance carbon dioxide or nitrogen, preferably at high temperature, in order to maintain the heat of the mold. During the drying, the heat provided by the heating means is conveyed to the core of the material of the pot to be dried by the gases, in particular the water vapor produced by evaporation of the water. The evacuation of the water vapor as the drying progresses thus makes the heating less efficient, simply because of the gradual disappearance of the heat transfer medium. The injection of a gas permits to maintain a transfer medium for an efficient conveying of the heat, while evacuating the water vapor; the use of an inert gas limits the risks of combustion of the heated organic material.

At semi-industrial or industrial scale, an installation according to the invention can of course comprise not one, but a plurality of drying molds fixed on a tray or a roller. The mechanical displacement of the molds, for example between a molding station and a drying station, is thus facilitated.

The invention also relates to an installation for manufacturing a biodegradable pot with thin walls for the cultivation of plants, which installation comprises:
a molding die, a wall of which has a shape adapted to a corresponding shape of the wall of a pot to be manufactured, the wall of the molding die being made of a mesh material, and a suction means for sucking and pressing a liquid clay against the wall of the molding die,
a transfer counter-mold, a wall of which has a shape adapted to a corresponding shape of the wall of a pot to be manufactured,
a drying installation as described above, wherein the wall of the drying mold is made of a solid material or an openwork material, a percentage of open area of which is at least twice smaller than a corresponding percentage of open area corresponding to the mesh material forming the wall of the molding die.

In such an installation, a pot is molded by sucking clay into the molding die, then drained. The molded and wet pot is then transferred to the drying mold through the transfer counter-mold having a shape adapted to the pot. Thus, the pot does not deform during the transfer to the drying mold. In addition, since the wall of the drying mold is made of a solid material or an openwork material having a small percentage of open area, the asperities formed on the walls of the pot during molding are attenuated, flattened, and even erased. The drying is then carried out in the drying mold, at a temperature above 160° C., and preferably between 180 and 240° C., as explained above.

The invention also relates to a drying method likely to be implemented in an installation as described above, the method comprising the steps of:
placing a molded pot in the drying mold,
heating the wall of the drying mold for a predetermined period of time at a temperature above 160° C., and preferably between 180 and 240° C.

Heating the mold at high temperature permits a through drying and a fast drying, which reduces the deformations of the molded pot when it is still malleable, and limits the energy consumption required for drying.

The predefined period of time for the drying ranges from several tens of seconds to several minutes, depending on the composition of the clay to be dried and the thickness of the pot.

The method can also comprise a step of sucking a fluid through the wall of the mold, said sucking step being performed before and/or during the drying step. The drying time is thus further reduced.

The method can also comprise a step of positioning and pressing a drying counter-mold against the wall of the pot, in order to compress said pot between the mold and the drying counter-mold, the pressing step being carried out during the drying step. The drying time is thus further reduced.

Finally, the invention relates to a biodegradable pot with thin walls adapted for the growth of plants, obtained by a method as described above and/or from a drying or manufacturing installation as described above, and a unit comprising a plant in a pot according to the invention.

### BRIEF DESCRIPTION OF THE DRAWINGS

The invention will be better understood and further features and advantages of the invention will become clear from the following description of examples of installation and method according to the invention. These examples are given in a non-restrictive way. The description should be read in conjunction with the attached drawings, in which:

FIG. 1 schematically shows the steps of a method according to the invention

FIG. 2 schematically shows the main elements of an installation according to the invention.

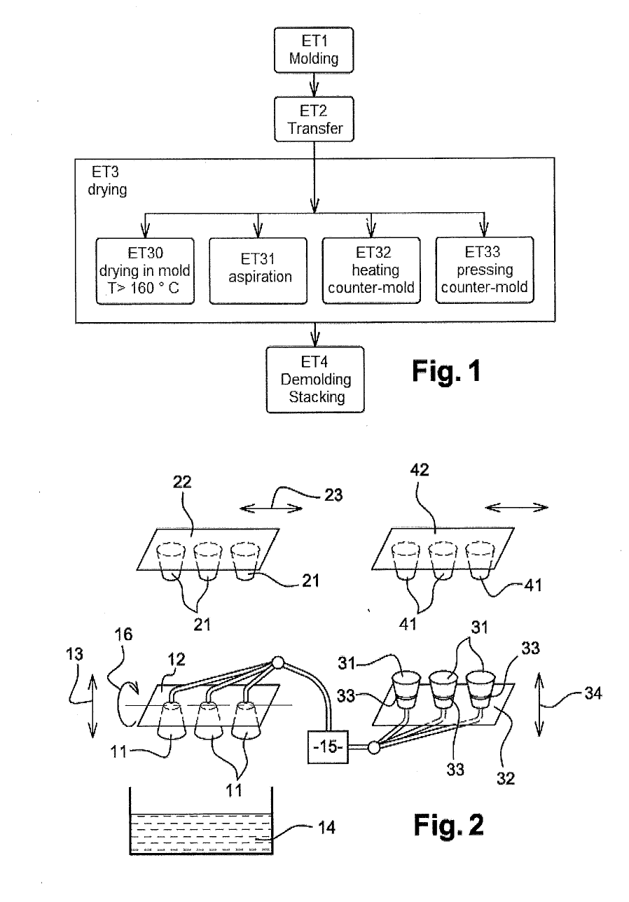

### DETAILED DESCRIPTION OF THE INVENTION

As previously stated, the invention provides a solution for improving the drying of biodegradable pots during industrial production of such pots, the improvement of the drying resulting into a significant improvement in unstackability of the pots, but also into a better stability of organic material resulting into a better mechanical strength of the pots.

An installation for manufacturing pots according to the invention at industrial scale namely comprises an installation for molding pots, a pot transfer installation and an installation for drying pots, all three operating in an integrated manner and cyclically. An installation is shown very schematically in FIG. 2, adapted for manufacturing only three pots, for reasons of clarity of the diagram. Also for reasons of simplicity, the means for moving the molds are not shown, only the possible movements of the molds are represented by arrows.

The molding plant comprises a plurality of molding dies 11 fixed for example in rows on a tray 12. The molding dies have for example the shape of a truncated cone 11, a substantially parallelepiped shape, etc. A driving means (not shown in FIG. 2) drives the tray (arrow 13) and the molds inside a bath 14 of clay to be molded, and a suction means 15 sucks the clay through the walls of the molds 11 in order to press a suitable quantity of clay against the wall of the mold 11.

The transfer installation comprises a plurality of counter-molds 21 fixed on a tray 22 in correspondence with the molding dies, a turning means (not shown) for turning the tray 12 (arrow 16), the driving means (arrow 13) then transferring the molded pots onto or into the counter-molds 21, a pressing means (not shown) for pressing the counter-molds 21 against the molded clay in the molds 11, for draining the molded pots, and means (not shown) for transferring (arrow 23) the pots into or onto the drying molds 31.

The drying installation comprises a plurality of drying molds 31 fixed in rows on a tray 32, in correspondence with the transfer counter-molds 21. Each drying mold 31 has a wall having a shape adapted to a corresponding shape of a wall of a molded pot to be dried. The drying plant also comprises means for heating the wall of the drying mold at a temperature above 160° C., and preferably between 180 and 240° C. The heating means comprises, for example:
a plurality of electrical resistors 33, one resistor being wound around and outside each drying mold, and
means (not shown) for controlling an electric current supplied to the resistors and/or a resistivity value of the electrical heating resistors, depending on the temperature desired for the wall of the drying mold.

The drying plant is preferably complemented with means for sucking a fluid such as water and/or water vapor through at least part of the wall of each drying mold. The suction means comprises for example:
a vacuum pump 15, connected by a pipe to one or more connecting nozzles fixed to an outer shell of the drying molds;
means for controlling (not shown) the negative pressure generated by the vacuum pump, depending on the amount of fluid to be extracted, and the force to be applied to extract the water or water vapor from the pot to be dried.

In the installation shown, the same vacuum pump 15 is used for the drying molds and the molding dies. Of course, it is also possible to use different vacuum pumps for these two functions.

The wall of the drying molds is made of a heat resistant material, a material resistant to the pressure difference likely to be generated by the suction means, and resistant in time for use namely in a wet environment. The wall of the molds is thus made for example of stainless steel, aluminum, etc. Preferably, the wall of the molds is made of a solid material. It can also be made of an openwork material such as an openwork sheet, a percentage of open area of which is less than 25%. In this case, in order to permit the implementation of the suction means, it is provided to position the molds in an air-tight shell connected, for example, by a nozzle to the hose for connecting the vacuum pump.

The drying installation is advantageously complemented with a means for closing the molds to be dried, such as a counter-mold, one wall of which has a shape adapted to a corresponding shape of a wall of the pot. In the example shown in FIG. 2, the closing means is formed of a tray 42 on which are fixed a plurality of counter-molds 41. A heating means (not shown) is provided for heating the wall of the drying counter-mold at a temperature above 160° C., and preferably between 180 to 240° C.; the heating means is for example similar to the means for heating the mold. A pressing means is also provided for pressing the counter-mold against the mold, in order to compress the pot between the drying counter-mold and the drying mold. The pressing means comprises for example means for moving in translation the mold 31 (arrow 34) and pressing the mold 31 against the corresponding counter-mold 41, with a predetermined pressure.

A preferred method likely to be implemented on an installation as described above comprises the following steps: a molding step ET1, a transfer step ET2 and a drying step ET3.

During the molding step ET1, the molding dies are dipped into a bath of liquid clay, and the clay is sucked against the wall of the molding dies. During the transfer step ET2, the molded pots are first of all drained by a counter-mold, then transferred onto the counter-mold.

During the drying step ET3, the pots are placed from the transfer counter-mold into the drying molds, the wall of the drying mold being heated at a temperature above 160° C. (ET30), and preferably between 180 and 240° C., for a predefined period of time ranging from several tens of seconds to several minutes.

Before and/or during the drying step can also be performed:
a step of sucking (ET31) a fluid through the wall of the molds or counter-molds, and/or
a step of positioning and heating (ET32) a drying counter-mold against the pots, and/or
a step of positioning and pressing (ET33) a drying counter-mold against the pots, for compressing said pots between the molds and the drying counter-molds.

A de-molding and stacking step ET4 is performed at the end of the drying.

It should be noted that a plant according to the invention has been made using female-type (concave) molding dies and drying molds and male-type (convex) transfer and drying counter-mold. In this configuration, the pots are molded and dried “in” molds, and transferred “onto” counter-molds. But the opposite can of course be considered.

The installation according to the invention has been tested at different temperatures, and the quality of the obtained pots has been tested in order to optimize the manufacture of the pots.

An important parameter for characterizing the pots is the biochemical stability index. This standardized index permits to objectively quantify the degradation kinetics of the organic materials, and more specifically the amount of organic material remaining in the soil (and enriching the soil), at 5-10 years. The calculation of this index takes into account the composition of the material, and namely its composition in soluble sugar, cellulose and lignin, main components of any organic material and the proportions of which determine the biodegradability. An index of about 1 corresponds to a biological material the biodegradability of which is the poorest, e.g., pine bark, known as degrading very slowly. On the other hand, an index close to 0 corresponds to a material that degrades very quickly, straw for example.

The analysis of the biochemical stability of the pots performed using an installation according to the invention provides the following results for pots at the exit of the installation:

| | Drying with | Drying with |
|---|---|---|
| | T < 140-160° C. | 160° C. < T < 240° C. |
| (Weight) percentage of organic material (OM) | 84.2% | 85.8% |
| in a pot | | |
| (Weight) percentage of soluble sugar in the organic | 2% | 6.9% |
| material | | |
| (Weight) percentage of cellulose in the organic | 51.2% | 49.8% |
| material | | |
| (Weight) percentage of lignin in the organic | 32.8% | 36.3% |
| material | | |
| Biochemical stability index | 0.35 | 0.52 |

Thus, the pots obtained by drying at a temperature above 160° C. have a biochemical stability index of 0.52, well above the biochemical stability index of the pots dried at lower temperature. They are therefore less readily biodegradable, which provides them with a better mechanical strength throughout the growth period when they must be handled, filled and wet.

This has also been verified during tests performed on the growth: the filled and wet pots start to tear on average after a globally longer period of time than the previous pots.

1. An installation for drying a biodegradable pot with thin walls for the growing of plants, which installation comprises a drying mold, a wall of which has a shape adapted to a corresponding shape of a wall of a molded pot to be dried, and means for heating the wall of the drying mold at a temperature above 160° C., and preferably between 180 and 240° C.

2. An installation according to claim 1, also comprising a means for sucking a fluid such as water and/or water vapor through at least a portion of the wall of the drying mold.

3. An installation according to claim 1, wherein the wall of the drying mold is made of a solid material, or of an openwork material, a percentage of open area of which is less than 25%.

4. An installation according to claim 1, also comprising means for closing the drying mold.

5. An installation according to claim 4, wherein the means for closing is a drying counter-mold, a wall of which has a shape adapted to a corresponding shape of a wall of the pot.

6. An installation according to claim 5, also comprising means for heating the wall of the drying counter-mold at a temperature above 160° C., and preferably between 180 to 240° C.

7. An installation according to claim 5, also comprising pressing means for compressing the pot between the drying counter-mold and the drying mold.

8. An installation according to claim 4, wherein the means for closing the drying mold is a cover.

9. An installation according to claim 1, also comprising means for injecting an inert gas into the drying mold.

10. An installation according to claim 1, comprising a plurality of drying molds fixed on a tray or a roller.

11. An installation for manufacturing a biodegradable pot with thin walls for growing plants, which installation comprises:
a molding die, a wall of which has a shape adapted to a corresponding shape of a pot to be manufactured, the wall of the molding die being made of a mesh material, and a suction means for sucking and pressing a liquid clay against the wall of the molding die,
a transfer counter-mold, a wall of which has a shape adapted to a corresponding shape of a pot to be manufactured,
a drying installation according to one of the preceding claims, wherein the wall of the drying mold is made of a solid material or an openwork material, a percentage of open area of which is at least twice smaller than a corresponding percentage of open area of the mesh material forming the wall of the molding die.

12. A drying method to be implemented in an installation according to claim 1, the method comprising the steps of:
placing a molded pot in the drying mold,
heating the wall of the drying mold for a predetermined period of time at a temperature above 160° C., and preferably between 180 and 240° C.

13. A method according to claim 11, wherein the predetermined time ranges from a few tens of seconds to several minutes.

14. A method according to claim 11, also comprising a step of sucking a fluid through the wall of the mold, said suction step being performed before and/or during the drying step.

15. A method according to claim 11, also comprising a step of positioning and pressing a counter-mold against the mold, in order to compress said pot between the counter-mold and the mold, the step of pressing being performed during the drying step.

16. A biodegradable pot with thin walls adapted for growing plants, obtained by a method according to claim 12.

17. A unit comprising a plant in a pot according to claim 16.
